(19) United States
(12) Patent Application Publication
(10) Pub. No.: US 2015/0144509 A1
(43) Pub. Date: May 28, 2015

(54) SYSTEM AND DEVICE FOR TRANSPORT AND DELIVERY OF A MEDICATION

(71) Applicants: Bianca M. Viscusi, Niskayuna, NY (US); Carolyne Yue Guo, Niskayuna, NY (US)

(72) Inventors: Bianca M. Viscusi, Niskayuna, NY (US); Carolyne Yue Guo, Niskayuna, NY (US)

(21) Appl. No.: 14/552,445

(22) Filed: Nov. 24, 2014

Related U.S. Application Data
(60) Provisional application No. 61/909,346, filed on Nov. 26, 2013.

(51) Int. Cl. A45C 11/24; A61J 1/03

(52) U.S. Cl. CPC A45C 11/24; A61J 1/03
USPC 206/38

(57) ABSTRACT

In one embodiment, the invention provides a device for housing both a portable electronic device and a medication delivery device, the device comprising: a body having: a first compartment for holding a portable electronic device; and a second compartment for holding a medication delivery device.

### CROSS-REFERENCE TO RELATED APPLICATIONS

This application claims the benefit of co-pending U.S. Provisional Patent Application Ser. No. 61/909,346, filed 26 Nov. 2013, which is hereby incorporated herein as though fully set forth.

### BACKGROUND

Currently, many individuals find it necessary to keep available any number of medications for administration either to themselves or their family members. For example, given the prevalence of severe allergies—particularly food allergies—having available a dose of epinephrine can be life-saving. Without it, an individual exposed to such an allergen risks anaphylactic shock, which is estimated to result in approximately 1,000 deaths in the US each year. Other medications, such as insulin, for example, may be equally necessary to have at hand. Still other medications, even those not necessary for survival, may be equally desirable to have available.

It can be difficult, however, for an individual to remember to bring such medications with them when away from home. Even when an individual remembers to do so, such medications can be burdensome to carry. Epinephrine and insulin, for example, are administered via injection. As such, an individual must carry not just the medication itself, but also the mechanism for its delivery.

Auto-injection devices, such as the Auvi-Q™ and EpiPen® provide both a dose of epinephrine (typically 0.15 mg or 0.3 mg) and an injection device in a combined, pre-packaged device. Each, however, requires significant additional storage space. The Auvi-Q™, for example, is 3⅜″ high, 2″ wide, and ⅝″ thick. The EpiPen® is approximately 5″ long and 1″ in diameter.

### SUMMARY

In one embodiment, the invention provides a device for housing both a portable electronic device and a medication delivery device, the device comprising: a body having: a first compartment for holding a portable electronic device; and a second compartment for holding a medication delivery device.

In another embodiment, the invention provides a system for transporting a medication delivery device, the system comprising: a medication delivery device; and device for housing both a portable electronic device and the medication delivery device, the device comprising: a body having: a first compartment for holding the portable electronic device; and a second compartment for holding the medication delivery device.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-4 show perspective views of devices according to various embodiments of the invention.

FIGS. 5-6 show top views of devices according to various embodiments of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION

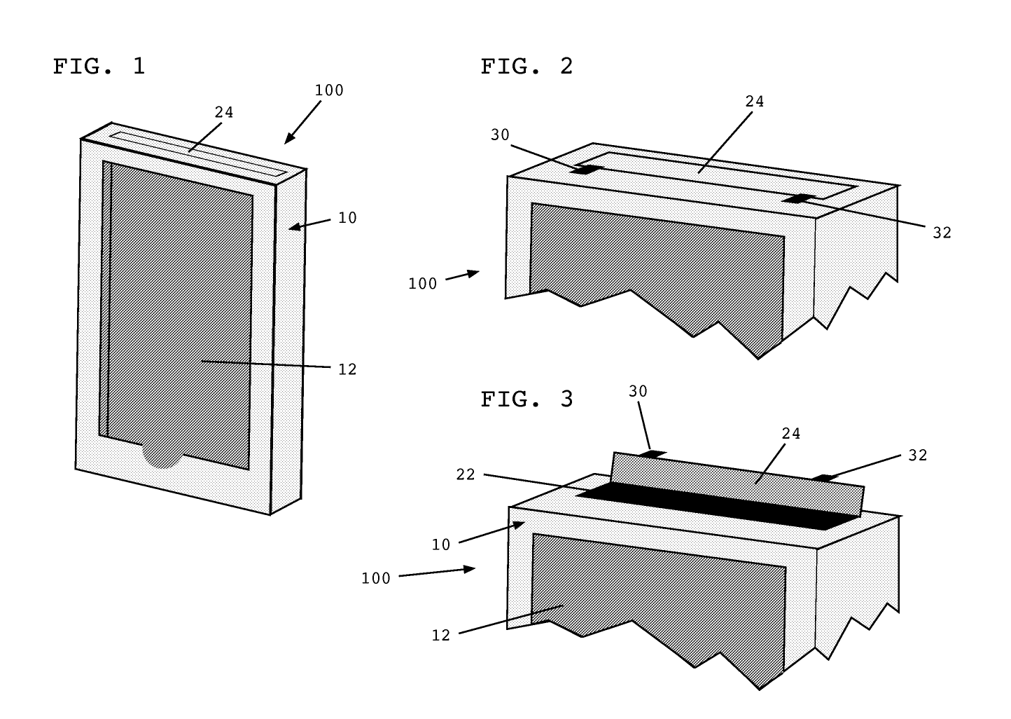

Turning now to the drawings, FIGS. 1-4 show a device 100 for housing a portable electronic device and a medication delivery device. Device 100 includes a body 10 within which are formed a first compartment 12 and a second compartment 22. First compartment 12 is open through at least one surface of body 10 and may be employed to house a portable electronic device, such as a mobile telephone, MP3 player, or the like.

Second compartment 22 includes a cover 24 for securing within second compartment 22 a medication delivery device. In a closed state, such as that shown in FIG. 2, cover 24 may be secured to body 10 by one or more latch devices 30,32 or similar mechanisms, as may be known in the art. In an opened state, such as that shown in FIG. 3, latch devices 30,32 are released from body 10 and cover 24, which remains affixed to body 10 along at least one surface, is opened to provide access to second compartment 22.

According to some embodiments of the invention, device 100 includes a pair of latch devices, as shown in FIGS. 2-3, each of which must be released in order to provide access to second compartment 22. As will be apparent to one skilled in the art, any number of arrangements of such latch devices may be employed. The arrangements shown in FIGS. 2-3 are provided merely for the purpose of illustration and explanation.

FIG. 4 shows another embodiment of the invention, wherein cover 24 is affixed to body 10 along its shorter edge. In other embodiments of the invention, cover may be completely removed from body 10.

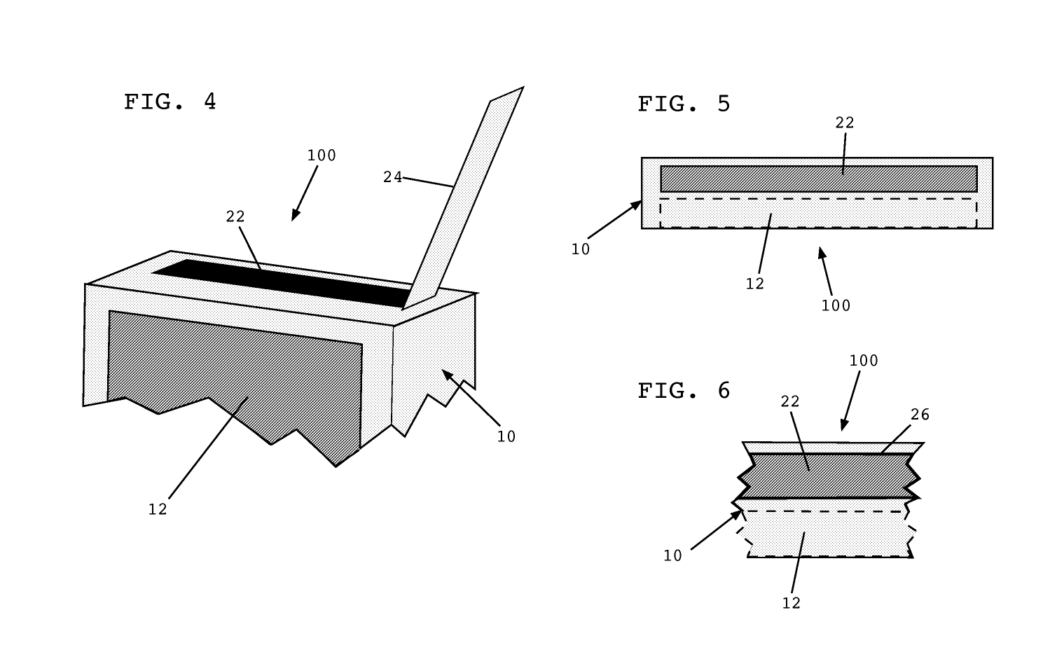

FIG. 5 shows a top view of device 100 and the relative positions of first compartment 12 (shown in phantom) and second compartment 22. FIG. 6 shows a detailed view of a portion of device 100, wherein second compartment 22 is lined with a pliable material 26, such as a silicon. Such an embodiment may be useful, for example, in providing additional protection to a medication delivery device secured within second compartment 22.

For example, according to some embodiments of the invention, the medication delivery device may be secured within second compartment 22 without the use of a separate housing, with which many medication delivery devices are typically provided. The Auvi-Q™ device, for example, is typically provided within a housing. This adds to the overall size of the Auvi-Q™ device, but becomes unnecessary when the Auvi-Q™ device itself is secured within second compartment 22, since significant protection is provided by body 10, which may include a rigid material, such as a polycarbonate, a polyethylene, a metal, etc. The inclusion of a pliable material 26 as a liner within second compartment 22 provides additional protection to the medication delivery device, obviating the need for a separate housing.

Device 100 and a medication delivery device may be provided together, as a system. For example, the Auvi-Q™ device, or a similar medication delivery device, may be ordered in combination with device 100, which a user may specify as applicable to house their own portable electronic device within first compartment 12.

Once expended or expired, however, the medication delivery device may be replaced without the need to replace device 100 itself. That is, replacement medication delivery devices, such as the Auvi-Q™ device, may be purchased or supplied for insertion into second compartment 22.

The various embodiment of the invention described above, as well as those which would be apparent to one skilled in the art, given the description above, provide several advantages. First, most individuals are less likely to forget their mobile telephone or other portable electronic device than they are their medication delivery device. By securing their medication delivery device and their mobile telephone or other portable electronic device within a common housing, they are more likely to have their medication delivery device at hand when needed. Second, by employing a common housing, such as device 100, less total space is taken up by a portable electronic device and a medication delivery device than if each were stored separately with their own housings.

Third, in the event of exposure to an allergen capable of inducing anaphylactic shock or in the event of some other medical emergency for which administration of a medication is needed, other than the medication delivery device itself, the most important device to have at hand is a telephone for summoning emergency medical attention. The devices according to the various embodiments of the invention described above ensure that both of these devices are at hand and available to a user in need of them.

The terminology used herein is for the purpose of describing particular embodiments only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for housing both a portable electronic device and a medication delivery device, the device comprising:
a body having:
a first compartment for holding a portable electronic device; and
a second compartment for holding a medication delivery device.

2. The device of claim 1, wherein the portable electronic device is a mobile telephone.

3. The device of claim 1, wherein the medication delivery device is a device for injecting a quantity of epinephrine.

4. The device of claim 3, wherein the medication delivery device includes the quantity of epinephrine.

5. The device of claim 1, wherein the body includes a rigid frame and the second compartment is lined with a pliable material.

6. The device of claim 5, wherein the pliable material includes a silicone.

7. The device of claim 1, wherein the second compartment includes a cover for restraining the medication delivery device.

8. The device of claim 7, wherein the cover is secured in a closed position using at least one latch device.

9. The device of claim 8, wherein the at least one latch device includes a pair of latch devices, each of which must be released to open the cover and provide access to the second compartment.

10. A system for transporting a medication delivery device, the system comprising:
a medication delivery device; and
device for housing both a portable electronic device and the medication delivery device, the device comprising:
a body having:
a first compartment for holding the portable electronic device; and
a second compartment for holding the medication delivery device.

11. The system of claim 10, wherein the portable electronic device is a mobile telephone.

12. The system of claim 10, wherein the medication delivery device is a device for injecting a quantity of epinephrine.

13. The system of claim 12, wherein the medication delivery device includes the quantity of epinephrine.

14. The system of claim 10, wherein the body includes a rigid frame and the second compartment is lined with a pliable material.

15. The system of claim 14, wherein the pliable material includes a silicone.

16. The system of claim 10, wherein the second compartment includes a cover for restraining the medication delivery device.

17. The system of claim 16, wherein the cover is secured in a closed position using at least one latch device.

18. The system of claim 17, wherein the at least one latch device includes a pair of latch devices, each of which must be released to open the cover and provide access to the second compartment.
